(19) United States
(12) Patent Application Publication
(10) Pub. No.: US 2008/0244084 A1
(43) Pub. Date: Oct. 2, 2008

(54) Method for improved network performance using smart maximum segment size

(75) Inventors: Herman Dietrich Dierks, Round Rock, TX (US); Kiet H. Lam, Round Rock, TX (US); Venkat Venkatsubra, Austin, TX (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINE CORPORATION, Armonk, NY (US)

(21) Appl. No.: 12/137,757

(22) Filed: Jun. 12, 2008

Related U.S. Application Data
(63) Continuation of application No. 11/301,729, filed on Dec. 13, 2005.

(51) Int. Cl. G06F 15/16

(52) U.S. Cl. 709/236

(57) ABSTRACT

A method, system, and computer program product for negotiating a smart maximum segment size of a network connection for a data transfer. A client request to initiate a network connection, which includes a first maximum segment size, is received at a server. The server calculates a second maximum segment size, wherein at least one of the first maximum segment size or the second maximum segment size is a cache line size aligned Ethernet frame size, or smart maximum segment size. The server determines the smaller of the first and second maximum segment sizes and sends the second maximum segment size to the client. The client then selects the smaller of the first and second maximum segment sizes, and sends an acknowledgement to the server to complete the connection. The smaller of the first and second maximum segment sizes is used for the network connection and subsequent data transfer.

### BACKGROUND OF THE INVENTION

1. Field of the Invention

The present invention relates generally to an improved data processing system, and more specifically, to a computer implemented method for improving network performance using smart maximum segment size.

2. Description of the Related Art

Cache refers to an upper level memory used in computers. When selecting memory systems, designers typically must balance performance and speed with cost and other limitations. In order to create the most effective machines possible, multiple types of memory are typically implemented. In most computer systems, the processor is more likely to request information that has recently been requested. Cache memory, which is faster but smaller than main memory, is used to store instructions and data used by the processor so that when an address line that is stored in cache is requested, the cache can present the information to the processor faster than if the information must be retrieved from main memory. Thus, cache memories improve performance.

Data may be transferred within a data processing system using different mechanisms. One mechanism is direct memory access (DMA), which allows for data transfers from memory to memory without using or involving a central processing unit (CPU), which as a result can be scheduled to perform other tasks. A DMA transfer essentially copies a block of memory from one device to another. For example, with DMA, data may be transferred from a random access memory (RAM) to a DMA resource, such as a hard disk drive, without requiring intervention from the CPU. DMA transfers also are used in sending data to other DMA resources, such as a graphics adapter or Ethernet adapter. In these examples, a DMA resource is any logic or circuitry that is able to initiate and master memory read/write cycles on a bus. This resource may be located on the motherboard of the computer or on some other pluggable card, such as a graphics adapter or a disk drive adapter.

On most modern computing systems, the system memory bus accesses the memory one full cache line at a time. The implication is that when data within the cache line is accessed, the entire cache line worth of data is fetched to the system cache memory from the main memory. This behavior generally improves system performance, as it is likely that other data within the cache line will also be accessed.

Although accessing data in the cache memory is much faster than accessing memory from the main memory, a performance problem can arise when the input/output (I/O) subsystem needs to perform a direct memory access operation from a network adapter to update data in main memory, wherein the memory does not have a full cache line worth of data. For example, if a full cache line of data is 128 bytes, when the I/O subsystem encounters a cache line with less than 128 bytes, the I/O subsystem must break the data into chunks, having sizes that are multiples of the power of 2 (e.g., 1, 2, 4, 8, 16, 32, 64, etc.). The direct memory access operation is then performed on each data chunk individually. At the memory controller level, rather than being able to perform a simple memory write operation to update the data in the main memory as was performed for the full cache lines having 128 bytes, the memory controller must now perform a read-modify-write operation for each data chunk. In other words, the memory controller must first read the entire cache line worth of data from main memory, modify a portion of the cache line with data from the I/O subsystem, and then write the entire cache line back into the main memory. The reason that the memory controller needs to do a read-modify-write is that the memory controller must protect the other remaining bytes in the cache line from being modified. Thus, the memory controller must read the full line, replace part of the line, and write the result back to main memory. This read-modify-write operation is a time-consuming process and degrades system performance. Compounding the performance problem is that the memory controller must perform this operation multiple times to transfer one none cache line size align data size from the I/O subsystem. A none cache line size align data size is a data size that is not a multiple of the cache line size. For example, if the cache line size is 128 bytes, any size that is not a multiple of 128 is a none cache size align data size.

Thus, the conventional method of data transfer is not an efficient use of the memory bus transaction. The additional overhead of transferring the remaining bytes which do not have a full cache line worth of data not only increases the latency of the transaction, but it also limits the bandwidth of the memory transfer. Normally, each memory controller can only handle a fixed number of memory bus transactions per second. This limit is a function of the clock frequency and the controller design.

### SUMMARY OF THE INVENTION

Embodiments of the present invention provide a computer implemented method, apparatus, and computer program product for improving network performance of data transfers using a smart maximum segment size. The mechanism of the present invention allows for negotiating a smart maximum segment size for a network connection when a client request to initiate a network connection is received at a server. The client request includes a first maximum segment size. The server calculates a second maximum segment size, wherein at least one of the first maximum segment size or the second maximum segment size is a cache line size aligned Ethernet frame size, or smart maximum segment size. The server determines the smaller of the first and second maximum segment sizes. The server then sends an acknowledgement of the request and the second maximum segment size to the client. When the client receives the acknowledgement, the client selects the smaller of the first and second maximum segment sizes, and sends an acknowledgement to the server to complete the connection. The server and client may then begin the data transfer wherein the smaller of the first and second maximum segment sizes is used for the network connection.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a network of data processing systems in which the present invention may be implemented;

FIG. 2 is a block diagram of a data processing system in which the present invention may be implemented;

FIG. 3 is a diagram illustrating components used in negotiating a smart maximum segment size in accordance with an illustrative embodiment of the present invention;

FIGS. 4A-C depict a table illustrating a comparison of an example data transfer in a typical transmission control protocol (TCP) connect vs. a data transfer using the smart maximum segment size negotiation of the present invention;

FIGS. 5A-5C are diagrams illustrating exemplary connection negotiation scenarios in accordance with illustrative embodiments of the present invention; and

FIG. 6 is a flowchart of a process for improving network performance using smart maximum segment size negotiation in accordance with an illustrative embodiment of the present invention.

### DETAILED DESCRIPTION OF THE PREFERRED EMBODIMENT

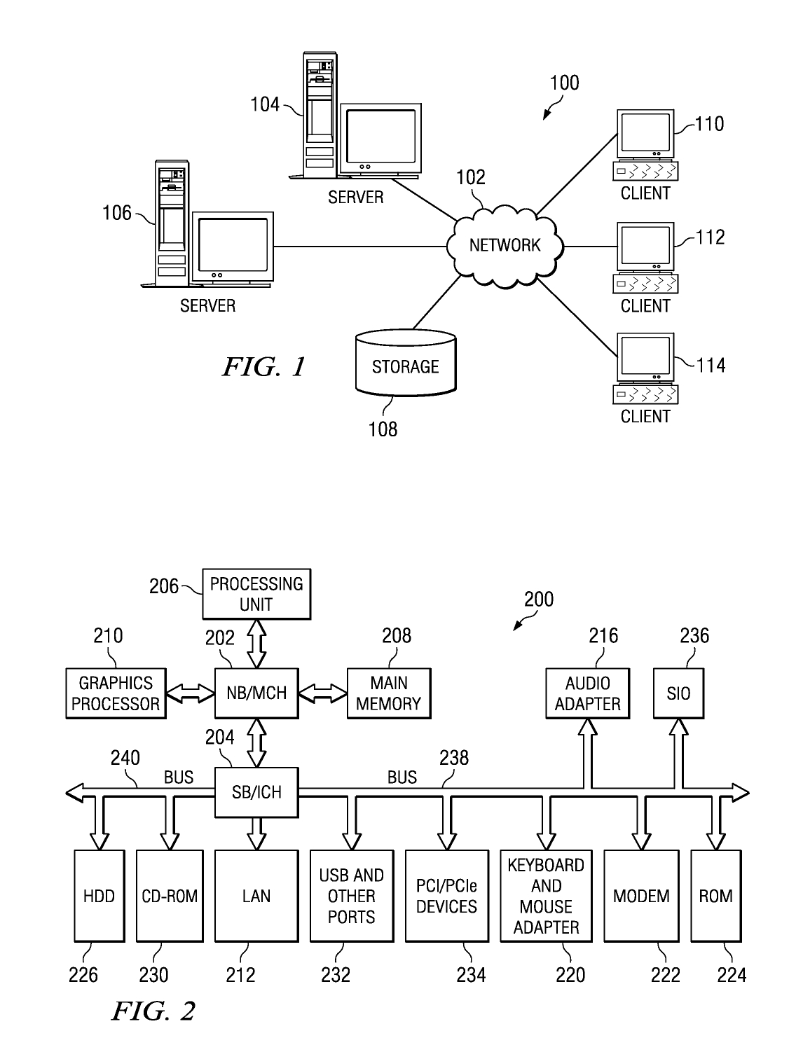

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

As previously mentioned, current systems experience performance problems when a network adapter attempts to perform a direct memory access on data that does not have a full cache line of data in main memory. Aspects of the present invention solve the performance issues in the existing art by negotiating a smart maximum segment size during the connection negotiation process. A maximum segment size (MSS) is the largest amount of data (in bytes) that a device can handle in a single, unfragmented piece. With the mechanism of the present invention, a smart maximum segment size may be negotiated that results in a cache line size aligned Ethernet frame (packet) size. A cache line size aligned Ethernet frame size is defined as the size of data that is a multiple of the cache line size in a direct memory access between the Ethernet adapter and the system memory. An Ethernet frame may consist of Ethernet header, Ethernet CRC trailer, TCP/IP header, and data. With the mechanism of the present invention, performance may be improved over existing systems, particularly when running a large number of Ethernet adapters.

The illustrative examples of the present invention are described using communications taking place over a Transmission Control Protocol/Internet Protocol (TCP/IP) connection, although the use of a TCP connection to describe the mechanism of the present invention does not preclude this invention being implemented over any other protocols on the Internet or other networks. TCP is an end-to-end transport protocol that provides flow-controlled data transfer. The TCP connection may contain a sequenced stream of data exchanged between two systems, such as a client and a server. TCP divides the data stream into segments or packets for transmission. TCP controls the maximum size of the packets (maximum segment size) for each TCP connection. When the TCP connection is initiated, TCP negotiates the maximum segment size in accordance with embodiments of the present invention. Since it is more efficient to send the largest possible packet size on the network, the maximum size packets that TCP sends may have a major impact on bandwidth and performance.

Known implementations for performing a write operation use the maximum transmission unit (MTU) value minus the TCP/IP header length as the maximum segment size. The maximum segment size is based on the MTU in order to have every byte of the Ethernet frames filled to maximize the utilization of the frames. The MTU is a value for the largest amount of data (in bytes) that may be passed by a layer of a communications protocol. Although using the MTU allows for transferring the largest amount of data in the Ethernet frames, using MTU minus the TCP/IP header length as the maximum segment size also results in none cache size aligned packet sizes. A none cache line size aligned packet results in the last data chunk being less than the cache line size, and this forces the system to transfer the data in smaller chunks, having sizes that are multiples of the power of 2, and use the less efficient read-modify-write method as previously explained.

In contrast, the mechanism of the present invention allows TCP to negotiate a smart maximum segment size based on the MTU size of the underlying media. In particular, the TCP subtracts from the MTU the number of octets required for the most common IP and TCP header sizes and the Ethernet frame header size. Thus, the smart maximum segment size resulting in cache line aligned Ethernet frames size is smaller than the none optimized maximum segment size.

In one illustrative embodiment of the present invention, the smart maximum segment size may be obtained by determining the number of cache lines to be transferred:

$$Number of Cache Lines = integer division of ( MT U size + Ethernet frame header length + Ethernet cyclical redundancycheck ( CRC ) trailer length ) by ( cache line size )$$

The cache line size in the formula above is system dependent. It may be predefined or queried at run time.

Once the number of cache lines has been identified, the maximum segment size may be determined:

$$Smart MSS = ( number of cache lines * cache line size ) - TCP / IP header length - Ethernet frame header length - Ethernet CRC trailer length$$

It should be noted that the Ethernet CRC trailer length may be 0 if the network adapter does not transfer the CRC trailer into memory per the adapter configuration. The transfer may be determined at run time by querying the adapter configuration.

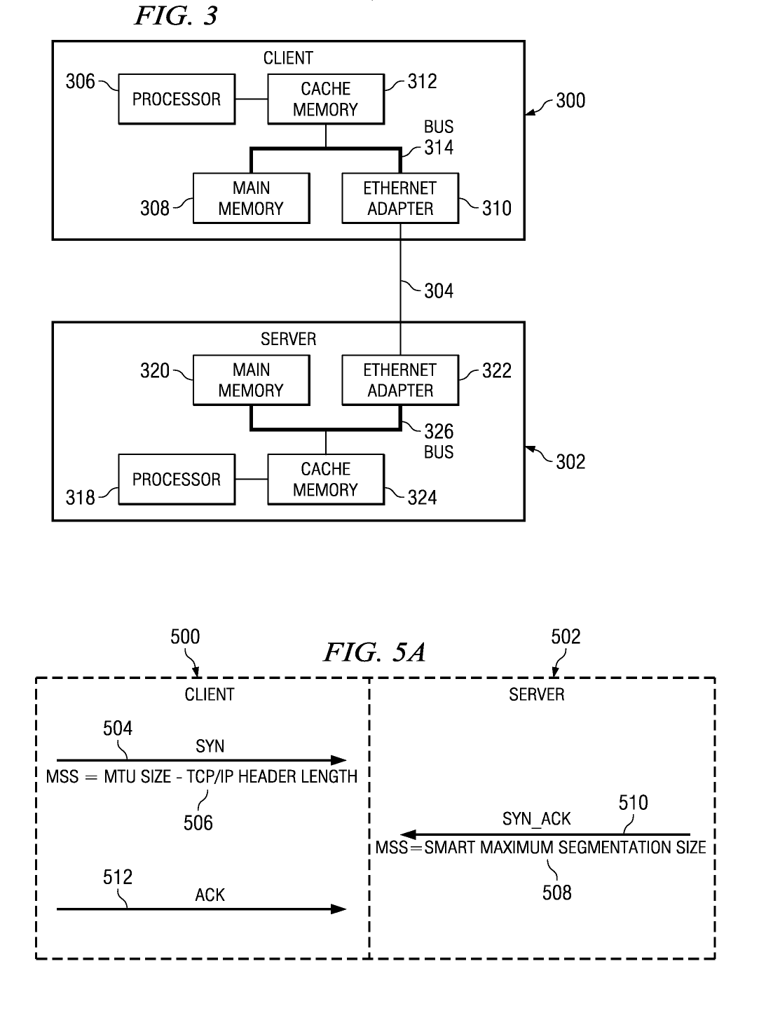

FIG. 3 is a diagram illustrating components used in negotiating a smart maximum segment size in accordance with an illustrative embodiment of the present invention. Client 300 shown in FIG. 3 is an example client, such as clients 110-114 in FIG. 1, and server 302 is an example server, such as servers 104 and 106 in FIG. 1.

In this illustrative example, client 300 is connected to server 302 over a network, such as network 304. Client 300 comprises processor 306, main memory 308, Ethernet adapter 310, and cache memory 312. Processor 306 is connected to main memory 308 and Ethernet adapter 310 via bus 314. Client 300 is connected to server 302 via network 304. Ethernet adapter 310 serves as the interface to network 304.

Server 302 comprises processor 318, main memory 320, Ethernet adapter 322, and cache memory 324. Processor 318 is connected to main memory 320 and Ethernet adapter 322 via bus 326. Ethernet adapter 322 serves as the interface to network 304.

A direct memory access operation may be performed between main memory and an adapter, such as main memory 308 and Ethernet adapter 310. For example, when client 300 wants to request data residing on server 302, client 300 initiates a TCP connection to server 302 by sending a connect request to server 302. The requested data may be passed in a DMA data stream from main memory 320 to Ethernet adapter 322 via bus 326. The requested data is then passed to Ethernet adapter 310 on client 300 via network 304 via the TCP connection, and to main memory 308 via bus 314.

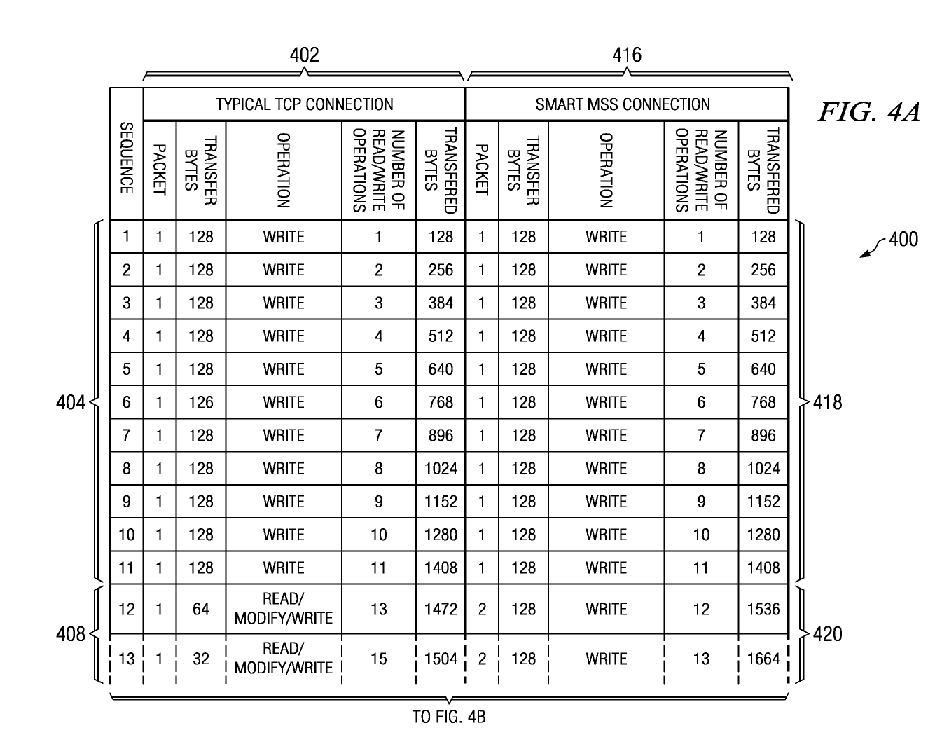

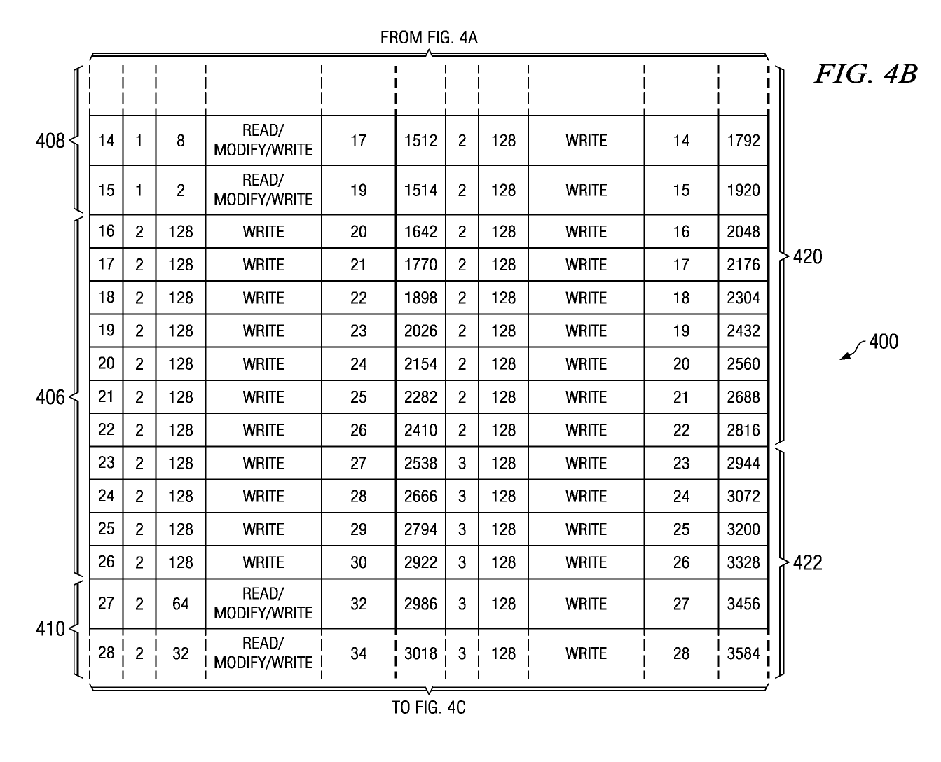

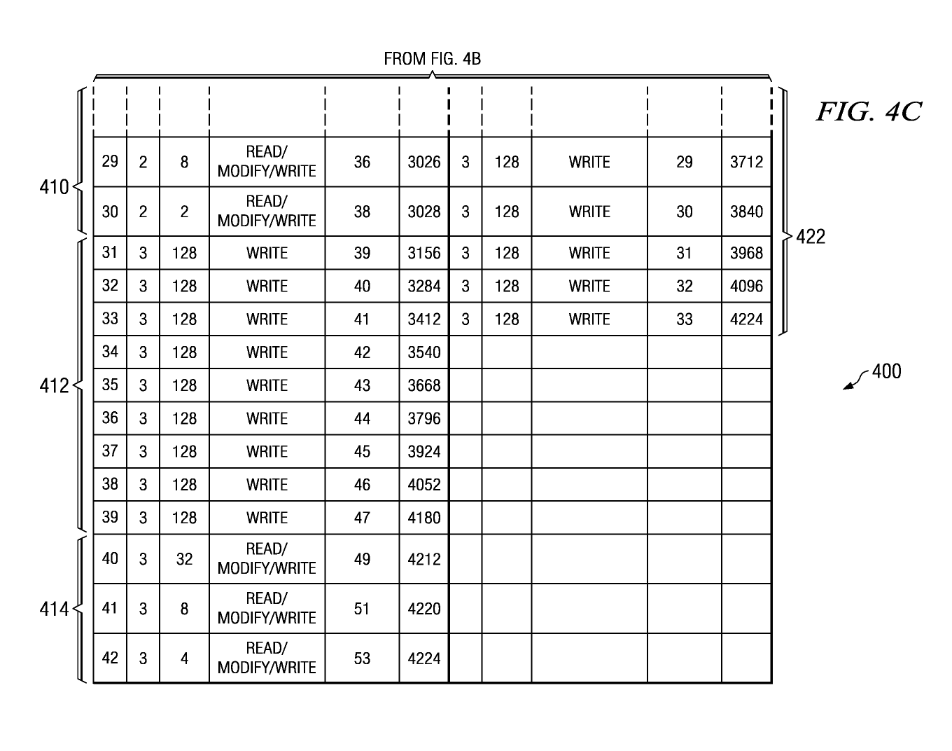

FIGS. 4A-C depict a table illustrating a comparison of an example data transfer in a typical TCP connect vs. a data transfer using the smart maximum segment size negotiation of the present invention. In this example, table 400 in FIGS. 4A-C illustrates a data transfer sending a message of 4062 bytes over a TCP/IP connection using Ethernet adapters as the transport devices.

In the traditional TCP connection process 402, the maximum transfer unit (MTU) size is used to establish the TCP connection between the Ethernet adapter and main memory. The MTU is used to determine the maximum value needed to fill every byte of the Ethernet frames to maximize their use. In this example, the Ethernet adapters are running a typical MTU size of 1500 bytes. The maximum segment size of the data packet is 1460 bytes (MTU (1500)-TCP/IP header length (40)). Thus, to transfer the 4062 bytes of data, TCP must send the data in three packets of 1460, 1460, and 1142 bytes, respectively. The Ethernet frame sizes for the data packets are 1514 bytes for the payload of each of the 1460 byte packets and 1196 for the payload of the 1142 byte packets (Ethernet frame size=Ethernet frame header (14 bytes)+TCP/IP header (40 bytes)+packet payload). Thus, the total amount of data transfer to the system memory is 4224 bytes (1514+1514+1196), which is performed in 53 read and write operations with the three packets.

For each packet 1 and 2, the transfer of the 1514 bytes of data into the main memory using a 128 byte cache line consists of eleven direct memory access write operations 404, 406 of 128 bytes chunks (1408 bytes total) plus four direct memory access read-modify-write operations 408, 410 for the remaining 106 bytes. For packet 3, the transfer of the 1196 bytes of data into the main memory consists of nine direct memory access write operations 412 in 128 byte chunks (1152 bytes total) plus three direct memory access read-modify-write operations 414 for the remaining 44 bytes.

In contrast with the first 1408 bytes for packets 1 and 2 and the first 1152 bytes for packet 3, the memory controller must perform read-modify-write operations on the data in main memory for the remaining 106 bytes and 44 bytes. For each chunk of data, the memory controller reads the entire cache line worth of data from main memory, modifies a portion of the cache line with data from the I/O subsystem, and then writes the entire cache line back into the main memory. The memory controller is required to perform a read-modify-write for each chunk of the remaining 106 bytes and 44 bytes in order to protect the other remaining bytes in the cache line from being modified until the direct memory access operation is completed. Thus, the memory controller must read the full line, replace part of the line, and write the result back to main memory.

The inefficiency of transferring none cache size aligned data is evident in sequences 12-15 and 27-30 (read-modify-write operations 408 and 410). The remaining 106 bytes of data in packet 1 are divided by the I/O subsystem into chunks with sizes that are multiples of the power of two, such as 1, 2, 4, 8, 16, 32, 64, etc. In this illustrative example, the remaining 106 bytes are transferred in 64, 32, 8, and 2 bytes chunks in sequence 12 through 15. Likewise, the remaining 44 bytes of data in packet 3 (read-modify-write operations 414) are transferred in 32, 8, and 2 byte chunks in sequence 40-42 (read-modify-write operations 414). Thus, the typical TCP connection 402 example above illustrates the costly overhead of transferring the remaining bytes of data, as the last 106 bytes of data require eight bus operations (four read/write pairs), compared to just eleven write operations for the first 1408 bytes of data, and the last 44 bytes of data requires six bus operations (three read/write pairs), compared to just nine write operations for the first 1196 bytes of data.

In contrast, a connection negotiation using the mechanism of the present invention 416 may be performed by calculating a smart maximum segment size of the data packet using the formulas previously described above. Using a cache line size of 128 and an Ethernet CRC trailer length of 14, the number of cache lines may be calculated as:

number of cache lines=(1500+14+0)/128=11

wherein 1500 is the MTU size, 14 is the Ethernet frame header length, 0 is the Ethernet CRC trailer length, and 128 is the cache line size. From the formula above, it is shown that eleven cache lines of data are needed.

The smart maximum segment size may be calculated as:

Smart MSS=(11*128)−40−14−0=1354

wherein 11 is the number of cache lines, 128 is the cache line size, 40 is the TCP/IP header length, 14 is the Ethernet frame header length, and 0 is the Ethernet CRC frame length.

As shown, the data transfer using the above formulas results in a smart maximum segment size of 1354 (using a cache line size of 128). Thus, TCP sends the data in three packets of 1354 bytes each. The smart maximum segment size of 1354 results in an Ethernet frame size of 1408 bytes (1354 maximum segment size+40 TCP/IP header+14 Ethernet frame header). Thus, the total amount of data transfer to the system memory is 4224 bytes (1408+1408+1408).

The transfer of each of the three packets of 1408 bytes of data into the main memory consists of eleven direct memory access writes of 128 bytes chunks 418, 420, 422, for a total of 33 write operations. In comparison with the traditional TCP connection process which requires 53 read and write operations, using the mechanism of the present invention in this particular scenario provides an efficiency improvement of 60% (e.g., (53−33)/33*100).

The mechanism of the present invention eliminates the bus operations (read/write pairs in sequence 12 through 15) used for transferring the remaining bytes of data in the traditional TCP data transfer process 402, such as remaining 106 bytes 408, 410 and remaining 44 bytes 414. Thus, with the mechanism of the present invention, when the smart maximum segment is calculated, the full cache lines may be transferred, and any additional bytes of data that do not comprise a full cache line of data are ignored. These bus operations may now be used to transfer a full cache line of data for a subsequent data packet.

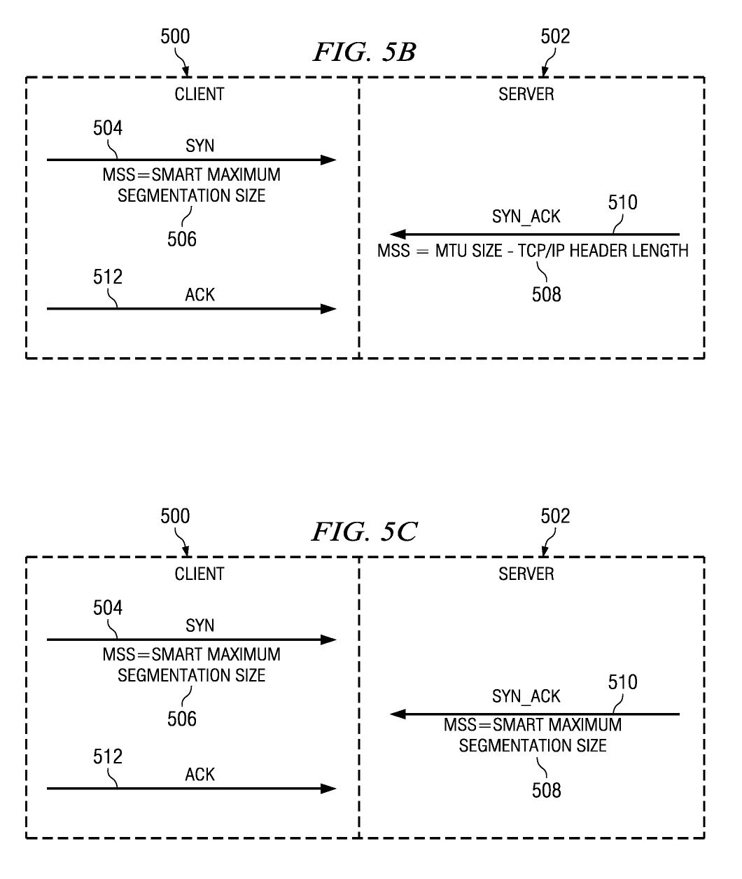

FIGS. 5A-5C are diagrams illustrating exemplary connection negotiation scenarios in accordance with illustrative embodiments of the present invention. The connection negotiation scenarios shown in FIGS. 5A-5C may be implemented between a client and a server, such as client 300 and server 302 in FIG. 3.

FIG. 5A illustrates an example connection negotiation between client 500 and server 502, wherein only server 502 employs the smart maximum segment size negotiation of the present invention. In this scenario, client 500 initiates a TCP connection with server 502. Client 500 establishes the TCP connection by transmitting a connect request to server 502. Client 500 sends server 502 a TCP packet with the SYN bit enabled (TCP SYN 504) and a maximum segment size 506, calculated as shown below:

MSS=MTU−TCP/IP header length

When the SYN packet is received at server 502 which has the smart maximum segment size implementation, server 502 computes a maximum segment size using the smart maximum segment size formula in accordance with the present invention as shown below.

Smart MSS=(number of cache lines*cache line size)−TCP/IP header length−Ethernet frame header length−Ethernet CRC trailer length

wherein:

Number of Cache Lines=integer division of (MTU size+Ethernet frame header length+Ethernet cyclical redundancy check (CRC) trailer length)/(cache line size)

Server 502 then responds to client 500 by connecting to client 500 using the calculated smart maximum segment size 508, and transmits an acknowledgement (TCP SYN_ACK 510).

Smart maximum segment size 508 calculated by server 502 is smaller than the maximum segment size issued by client 500. The mechanism of the present invention uses the lower of maximum segment size numbers 506 and 508 calculated by the client and server respectively for the TCP connection. Upon receiving the TCP SYN_ACK packet from the server, client 500 completes the connection request by acknowledging (TCP ACK 512) server 502's acknowledgement of the client's initial request. Client 500 abides to use the smaller of the two maximum segment size values. TCP protocol requires the connection to user the smaller of the two maximum segment sizes, and the client selects the smaller maximum segment size value when the client receives the SYN_ACK from the server, which results in most of the network data transfer over the I/O subsystem on server 502 to be cache line size aligned. Thus, the subsequent data transfer will use the negotiated connection maximum segment size.

FIG. 5B illustrates an example connection negotiation between client 500 and server 502, wherein only client 500 contains the smart maximum segment size implementation of the present invention. In this scenario, client 500, which has the smart maximum segment size implementation, initiates the TCP connection by sending a TCP packet with the SYN bit enabled (TCP SYN 504) and a maximum segment size 506 calculated using the smart maximum segment size formula described in FIG. 5A above.

When server 502, which does not have the smart maximum segment size implementation, receives the TCP SYN packet, the server acknowledges the request by responding to client 500 with its own calculated maximum segment size value of “MTU-TCP/IP header length”. Maximum segment size 508 calculated by server 502 is larger than the smart maximum segment size 506 issued by client 500. Server 502 abides to use the smaller smart maximum segment size 506 issued by the client. Upon receiving the SYN_ACK packet (TCP SYN_ACK 510) from server 502, client 500 acknowledges the server's acknowledgement of the client's initial request (TCP ACK 512).

FIG. 5C illustrates an example connection negotiation between client 500 and server 502, wherein both client 500 and server 502 contain the smart maximum segment size implementation of the present invention. In this scenario, client 500, initiates the TCP connection by sending a TCP packet with the SYN bit enabled (TCP SYN 504) and a maximum segment size 506 calculated using the smart maximum segment size formula described in FIG. 5A above.

When server 502 receives the SYN packet, the server responds to client using a maximum segment size 508 calculated using the smart maximum segment size formula described in FIG. 5A above. Server 502 selects the smaller of the two smart maximum segment size (506, 508) values to use as the TCP connection. Upon receiving the SYN_ACK packet (TCP SYN_ACK 510) from server 502, client 500 sends the acknowledgment (TCP ACK 512) and abides to use the smaller of the two smart maximum size values. Using the smaller of the two values results in most of the network data transfer over the I/O subsystem on the server to be cache line size aligned.

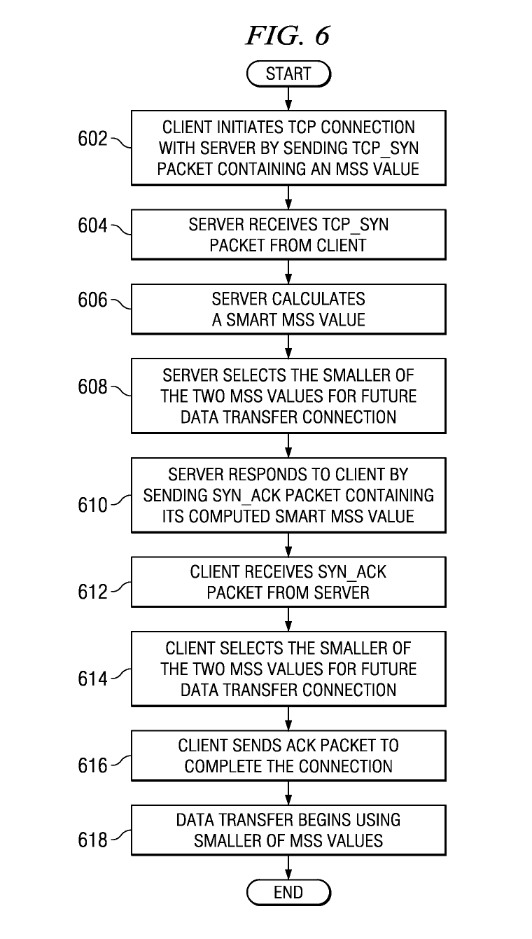

FIG. 6 is a flowchart of an exemplary process for improving network performance using a smart maximum segment size negotiation in accordance with an illustrative embodiment of the present invention. The process in FIG. 6 may be implemented between a client and a server, such as client 300 and server 302 in FIG. 3. In this illustrative process, the server is shown to employ the smart maximum segment negotiation in accordance with embodiments of the present invention.

The process begins with a client initiating a TCP connection with a server (step 602). In initiating the connection, the client sends a TCP_SYN packet to the server. The connect request may comprise a TCP packet (TCP SYN) and a maximum segment size value. The maximum segment size included in the request may be calculated in a traditional manner (e.g., MTU-TCP/IP header length), or the maximum segment size may be calculated by the client using the smart MSS formula described in FIG. 5A.

Upon receiving the TCP_SYN packet with the maximum segment size calculated by the client (step 604), the server calculates a smart maximum segment size using the smart maximum segment size formula described in FIG. 5A (step 606). The server selects the smaller of the maximum segment size calculated by the client and the maximum segment size calculated by the server to use for the future data transfer connection (step 608). The server responds to the client request by sending a SYN_ACK packet containing its calculated smart maximum segment size to the client (step 610).

When the client receives the SYN_ACK packet from the server (step 612), the client selects the smaller of the maximum segment sizes calculated by the server and the maximum segment size calculated by the client to use for the future data connection (step 614). The client then sends an ACK packet to the server to complete the connection negotiation (step 616). The data transfer then begins (step 618). The client and server abide by the smaller of the two maximum segment size values when the data is transferred. Using the smaller of the two values results in most of the network data transfer over the I/O subsystem on the server to be cache line size aligned.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and digital video disc (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented method for negotiating a maximum segment size for a network connection, the computer implemented method comprising:
receiving a request from a client to initiate a network connection, wherein the request includes a first maximum segment size;
responsive to receiving the request, calculating a second maximum segment size, wherein at least one of the first maximum segment size or the second maximum segment size is a cache line size aligned Ethernet frame size;
determining a smaller of the first maximum segment size and the second maximum segment size;
sending an acknowledgement of the request and the second maximum segment size to the client; and
receiving an acknowledgement from the client of the smaller of the first maximum segment size and the second maximum segment size, wherein the smaller of the first maximum segment size and the second maximum segment size is used for the network connection.

2. The computer implemented method of claim 1, further comprising:
beginning a data transfer using the smaller of the first maximum segment size and second maximum segment size for the network connection.

3. The computer implemented method of claim 1, wherein the cache line size aligned Ethernet frame size comprises a multiple of a cache line size in a direct memory access.

4. The computer implemented method of claim 3, wherein the at least one of the first maximum segment size and the second maximum segment size that is a cache line size aligned Ethernet frame size is calculated as follows:
MSS=(number of full cache lines to be transferred*cache line size)−TCP/IP header length−Ethernet frame header length−Ethernet CRC trailer length.

5. The computer implemented method of claim 4, wherein the number of full cache lines to be transferred is calculated as follows:
Number of full cache lines=(maximum transmission unit size+Ethernet frame header length+Ethernet cyclical redundancy check trailer length)/(cache line size).

6. The computer implemented method of claim 3, wherein the cache line size aligned Ethernet frame size is smaller than a none optimized maximum segment size.

7. The computer implemented method of claim 4, wherein the cache line size is system dependent.

8. The computer implemented method of claim 1, wherein the network connection is a TCP/IP connection.

9. A data processing system for negotiating a maximum segment size for a network connection, comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to receive a request from a client to initiate a network connection, wherein the request includes a first maximum segment size, calculate a second maximum segment size, wherein at least one of the first maximum segment size or the second maximum segment size is a cache line size aligned Ethernet frame size in response to receiving the request, determine a smaller of the first maximum segment size and the second maximum segment size, send an acknowledgement of the request and the second maximum segment size to the client, and receive an acknowledgement from the client of the smaller of the first maximum segment size and the second maximum segment size, wherein the smaller of the first maximum segment size and the second maximum segment sizes is used for the network connection.

10. The data processing system of claim 9, wherein the processing unit further executes the computer usable code to begin a data transfer using the smaller of the first maximum segment size and second maximum segment size for the network connection.

11. The data processing system of claim 9, wherein the cache line size aligned Ethernet frame size comprises a multiple of a cache line size in a direct memory access.

12. The data processing system of claim 11, wherein the at least one of the first maximum segment size and the second maximum segment size that is a cache line size aligned Ethernet frame size is calculated as follows:
MSS=(number of full cache lines to be transferred*cache line size)−TCP/IP header length−Ethernet frame header length−Ethernet CRC trailer length.

13. The data processing system method of claim 12, wherein the number of full cache lines to be transferred is calculated as follows:
Number of full cache lines=(maximum transmission unit size+Ethernet frame header length+Ethernet cyclical redundancy check trailer length)/(cache line size).

14. The data processing system of claim 11, wherein the cache line size aligned Ethernet frame size is smaller than a none optimized maximum segment size.

15. A computer program product for negotiating a maximum segment size for a network connection, the computer program product comprising:
a computer usable medium having computer usable program code tangibly embodied thereon, the computer usable program code comprising:
computer usable program code for receiving a request from a client to initiate a network connection, wherein the request includes a first maximum segment size;
computer usable program code for calculating a second maximum segment size, wherein at least one of the first maximum segment size or the second maximum segment size is a cache line size aligned Ethernet frame size in response to receiving the request;
computer usable program code for determining a smaller of the first maximum segment size and the second maximum segment size;
computer usable program code for sending an acknowledgement of the request and the second maximum segment size to the client; and
computer usable program code for receiving an acknowledgement from the client of the smaller of the first maximum segment size and the second maximum segment size, wherein the smaller of the first maximum segment size and the second maximum segment size is used for the network connection.

16. The computer program product of claim 15, further comprising:
beginning a data transfer using the smaller of the first maximum segment size and second maximum segment size for the network connection.

17. The computer program product of claim 15, wherein the cache line size aligned Ethernet frame size comprises a multiple of a cache line size in a direct memory access.

18. The computer program product of claim 17, wherein the at least one of the first maximum segment size and the second maximum segment size that is a cache line size aligned Ethernet frame size is calculated as follows:
MSS=(number of full cache lines to be transferred*cache line size)−TCP/IP header length−Ethernet frame header length−Ethernet CRC trailer length.

19. The computer program product of claim 18, wherein the number of full cache lines to be transferred is calculated as follows:
Number of full cache lines=(maximum transmission unit size+Ethernet frame header length+Ethernet cyclical redundancy check trailer length)/(cache line size).

20. The computer program product of claim 3, wherein the cache line size aligned Ethernet frame size is smaller than a none optimized maximum segment size.
